(19) United States
(12) Patent Application Publication
(10) Pub. No.: US 2024/0143604 A1
(43) Pub. Date: May 2, 2024

(54) METHOD FOR SEARCHING CONTENT AND SYSTEM THEREOF

(71) Applicant: SAMSUNG SDS CO., LTD., Seoul (KR)

(72) Inventors: Kyeong Soo JEONG, Seoul (KR); Yun Hee LEE, Seoul (KR)

(73) Assignee: SAMSUNG SDS CO., LTD., Seoul (KR)

(21) Appl. No.: 18/384,315

(22) Filed: Oct. 26, 2023

(30) Foreign Application Priority Data
Oct. 28, 2022 (KR) 10-2022-0141370

(51) Int. Cl. G06F 16/2457; G06F 16/28

(52) U.S. Cl. CPC G06F 16/24578; G06F 16/285

(57) ABSTRACT

Provided is a method performed by at least one processor, including: obtaining a content search term, the content search term including a first plurality of search keywords; performing a search for a plurality of contents using the first plurality of search keywords; extracting, based on no result of the search, a second plurality of search keywords from the first plurality of search keywords, wherein the second plurality of search keywords exclude keywords that are not included in a first keyword set, and the first keyword set includes keywords extracted from the plurality of contents; and performing a search for the plurality of contents using the second plurality of search keywords.

This application claims priority from Korean Patent Application No. 10-2022-0141370, filed on Oct. 28, 2022, in the Korean Intellectual Property Office, the disclosure of which is incorporated herein by reference in its entirety.

### BACKGROUND

### 1. Field

The present disclosure relates to a content search method for a plurality of contents and a server, to which the method is applied.

### 2. Description of the Related Art

According to the general content search method, when a user enters a search keyword, a search is performed in the content for the search keyword, if there is a search result, the search result is provided, and if there is no search result, a response that the search fails is provided to the user.

If the content search fails above, the user should perform re-search again. Ultimately, the user should search only keywords included in the content, and in order to obtain the search results the user wants, the user should attempt multiple searches to enter only search keywords with a high probability of producing search results. Therefore, users should spend a lot of time searching.

In order to improve the user's search convenience, methods such as separately registering hashtags or synonyms exist. However, according to the above method, costs are incurred for registering additional data in addition to the existing content.

Therefore, there is a need for a content search method that prevents users from wasting time by going through trial and error to search only keywords included in content and does not require registration of additional data in addition to existing content.

### PRIOR ART

Korean Patent Application Publication No. 10-2019-0005137 (published on Jan. 15, 2019)

### SUMMARY

The technical problem to be solved by the present disclosure is to provide a method and system for performing a search by excluding unnecessary keywords even if the user does not enter the correct keyword.

Another technical problem to be solve by the present disclosure is to provide a method of improving the search rate based only on existing content without performing additional work to improve the search rate in response to the user's inaccurate search term input.

Another technical problem to be solved by the present disclosure is to provide a method and a chatbot system of performing a search by excluding keywords that are not in the chatbot content among the search keywords entered by the user.

Another technical problem to be solved by the present disclosure is to provide a method and system for performing a search by excluding unnecessary keywords even if the user does not enter the correct keyword.

The technical problems of the present disclosure are not limited to the technical problems mentioned above, and other technical problems not mentioned can be clearly understood by those skilled in the art from the description below.

According to an aspect of the inventive concept, there may be provided a method performed by at least one processor, the method including: obtaining a content search term, the content search term including a first plurality of search keywords; performing a search for a plurality of contents using the first plurality of search keywords; extracting, based on no result of the search, a second plurality of search keywords from the first plurality of search keywords, wherein the second plurality of search keywords exclude keywords that are not included in a first keyword set, and the first keyword set includes keywords extracted from the plurality of contents; and performing a search for the plurality of contents using the second plurality of search keywords.

In some embodiments, the method may further include, based on there being no keyword that is not included in the first keyword set in the content search term: extracting a first keyword excluding keywords not included in a first content group from the second plurality of search keywords, and extracting a second keyword excluding keywords not included in a second content group from the second plurality of search keywords, wherein the first content group and the second content group are groups of contents included in the plurality of contents; and performing a search for the first content group using the first keyword and performing a search for the second content group using the second keyword.

In some embodiments, the method may further include: determining rankings of the first content group and the second content group based on search results for the first content group and the second content group; and providing a search result for a highest-ranked content group based on the determined rankings.

In some embodiments, the determining the rankings may include: extracting, from predetermined keyword score data, first keyword score data corresponding to a result of the search for the first content group using the first keyword; extracting, from the predetermined keyword score data, second keyword score data corresponding to a result of the search for the second content group using the second keyword; and determining the rankings of the first content group and the second content group using the first keyword score data and the second keyword score data, wherein the predetermined keyword score data include keywords included in each content group and scores matching the keywords included in each content group.

In some embodiments, the first keyword score data and the second keyword score data may be data determined using a BM25 algorithm.

In some embodiments, the method may further include, based on there being no result of the search using the second plurality of search keywords: extracting a third keyword excluding keywords not included in a third content group from the second plurality of search keywords, and extracting a fourth keyword excluding keywords not included in a fourth content group from the second plurality of search keywords, wherein the third content group and the fourth content group are groups of contents included in the plurality of contents; and performing a search for the third content group using the third keyword, and performing a search for the fourth content group using the fourth keyword.

In some embodiments, the method may further include: determining rankings of the third content group and the fourth content group based on search results for the third content group and the fourth content group; and providing a search result for a highest-ranked content group based on the determined rankings.

In some embodiments, the determining the rankings may include: extracting, from predetermined keyword score data, third keyword score data corresponding to a result of the search for the third content group using the third keyword; extracting, from the predetermined keyword score data, fourth keyword score data corresponding to a result of the search for the fourth content group using the fourth keyword; and determining the rankings of the third content group and the fourth content group using the third keyword score data and the fourth keyword score data, wherein the third or fourth keyword score data include keywords included in the third or fourth content group and scores matching the keywords included in the third or fourth content group.

In some embodiments, the third keyword score data and the fourth keyword score data may be data determined using a BM25 algorithm.

In some embodiments, the plurality of contents may be chatbot content, and the content search term may be a query entered by a user.

In some embodiments, the method may further include, prior to the obtaining the content search term: registering the plurality of contents, wherein the registering the plurality of contents includes: grouping the plurality of contents to generate grouping information for the plurality of contents; generating index information for the plurality of contents; and determining keyword scores for the plurality of contents using the grouping information and the index information and storing the keyword scores in a database.

According to an aspect of the inventive concept, there may be provided a method performed by at least one processor, the method including: obtaining a plurality of contents; grouping the plurality of contents to generate grouping information for the plurality of contents; generating index information for the plurality of contents; and determining a keyword score for each keyword included in the plurality of contents using the grouping information and the index information.

In some embodiments, the generating the grouping information may include generating first group information corresponding to a first content among the plurality of contents, the generating the index information may include: generating first index information corresponding to the first content among the plurality of contents, and the determining the keyword score may include: determining a keyword score for each keyword included in the first content using an Inverse Document Frequency (IDF) algorithm, a Term Frequency (TF) algorithm, and an NORM algorithm based on the first group information and the first index information.

According to an aspect of the inventive concept, there may be provided a server including: one or more processors; and a memory configured to store one or more instructions, wherein the one or more processors, by executing the stored one or more instructions, perform: obtaining a content search term, the content search term including a first plurality of search keywords; performing a search for a plurality of contents using the first plurality of search keywords; extracting, based on no result of the search, a second plurality of search keywords from the first plurality of search keywords, wherein the second plurality of search keywords exclude keywords that are not included in a first keyword set, and the first keyword set includes keywords extracted from the plurality of contents; and performing a search for the plurality of contents using the second plurality of search keywords.

In some embodiments, the one or more processors may further perform, based on no result of the search for the plurality of contents using the second plurality of search keywords: extracting a first keyword excluding keywords not included in a first content group from the second plurality of search keywords, and extracting a second keyword excluding keywords not included in a second content group from the second plurality of search keywords, wherein the first content group and the second content group are groups of contents included in the plurality of contents; and performing a search for the first content group using the first keyword and performing a search for the second content group using the second keyword.

In some embodiments, the one or more processors may further perform, based on there being no keyword that is not included in the first keyword set in the content search term: extracting a first keyword excluding keywords not included in a first content group from the second plurality of search keywords, and extracting a second keyword excluding keywords not included in a second content group from the second plurality of search keywords, wherein the first content group and the second content group are groups of contents included in the plurality of contents; and performing a search for the first content group using the first keyword and performing a search for the second content group using the second keyword.

In some embodiments, the one or more processors may further perform: determining rankings of the first content group and the second content group based on search results for the first content group and the second content group; and providing a search result for a highest-ranked content group based on the determined rankings.

In some embodiments, the determining the rankings may include: extracting, from predetermined keyword score data, first keyword score data corresponding to a result of the search for the first content group using the first keyword; extracting, from the predetermined keyword score data, second keyword score data corresponding to a result of the search for the second content group using the second keyword; and determining the rankings of the first content group and the second content group using the first keyword score data and the second keyword score data, wherein the predetermined keyword score data include keywords included in each content group and scores matching the keywords included in each content group.

The first keyword score data and the second keyword score data may be data determined using a BM25 algorithm.

The plurality of contents may be chatbot contents, and the content search term may be a query entered by a user.

### BRIEF DESCRIPTION OF THE DRAWINGS

These and/or other aspects will become apparent and more readily appreciated from the following description of the embodiments, taken in conjunction with the accompanying drawings in which:

FIG. 1 is a configuration diagram of a content search system according to an embodiment of the present disclosure;

FIG. 2 is a flowchart of a content search method according to another embodiment of the present disclosure;

FIGS. 3 and 4 are flowcharts of a content search method according to another embodiment of the present disclosure;

FIG. 5 is a flowchart of a content group ranking calculation method that may be referenced in some embodiments of the present disclosure;

FIG. 6 is a flowchart of a content registration method according to another embodiment of the present disclosure;

FIG. 7 is a diagram illustrating a plurality of contents that may be referenced in some embodiments of the present disclosure;

FIG. 8 is a diagram illustrating an example of the content group ranking calculation method described with reference to FIG. 5;

FIG. 9 is an example block diagram for describing a chatbot service providing server according to another embodiment of the present disclosure;

FIG. 10 is a flowchart of a method for providing a chatbot service according to another embodiment of the present disclosure;

FIG. 11 is a diagram illustrating chatbot content that may be referenced in some embodiments of the present disclosure;

FIG. 12 is a detailed flowchart describing in more detail the similarity calculation step described with reference to FIG. 11;

FIG. 13 is a diagram illustrating an example of the keyword frequency calculation step described with reference to FIG. 12;

FIG. 14 is a diagram illustrating an example of the similarity calculation step described with reference to FIG. 12;

FIG. 15 is a diagram illustrating an example of the results of performing the similarity calculation step described with reference to FIG. 12;

FIG. 16 is a flow chart describing the content grouping step described with reference to FIG. 10 in more detail;

FIG. 17 is a diagram illustrating an example of the content grouping step described with reference to FIG. 10;

FIG. 18 is a flowchart illustrating an example of the content group name setting step described with reference to FIG. 16;

FIG. 19 is a flow chart describing in more detail the chatbot service provision step described with reference to FIG. 10;

FIG. 20 is a diagram illustrating an example of the chatbot service provision step described with reference to FIG. 10; and

FIG. 21 is a hardware configuration diagram of a computing system according to some embodiments of the present disclosure.

### DETAILED DESCRIPTION

Hereinafter, preferred embodiments of the present disclosure will be described in detail with reference to the accompanying drawings. Advantages and features of the present invention, and methods of achieving them will become clear with reference to the detailed description of the following embodiments taken in conjunction with the accompanying drawings. However, the technical idea of the present invention is not limited to the following embodiments and can be implemented in various different forms. Only the following embodiments are provided to complete the technical idea of the present invention, and fully inform those skilled in the art of the technical field to which the present invention belongs the scope of the present invention, and the technical spirit of the present invention is defined by the scope of the claims and their equivalents.

In adding reference numerals to the components of each drawing, it should be noted that the same reference numerals are assigned to the same components as much as possible even though they are shown in different drawings. In addition, in describing the present disclosure, when it is determined that the detailed description of the related well-known configuration or function may obscure the gist of the present disclosure, the detailed description thereof will be omitted.

Unless otherwise defined, all terms used in the present specification (including technical and scientific terms) may be used in a sense that can be commonly understood by those skilled in the art. In addition, the terms defined in the commonly used dictionaries are not ideally or excessively interpreted unless they are specifically defined clearly. The terminology used herein is for the purpose of describing particular embodiments only and is not intended to be limiting of the disclosure. In this specification, the singular also includes the plural unless specifically stated otherwise in the phrase.

In addition, in describing the component of this disclosure, terms, such as first, second, A, B, (a), (b), can be used. These terms are only for distinguishing the components from other components, and the nature or order of the components is not limited by the terms. If a component is described as being “connected,” “coupled” or “contacted” to another component, that component may be directly connected to or contacted with that other component, but it should be understood that another component also may be “connected,” “coupled” or “contacted” between each component.

Hereinafter, embodiments of the present disclosure will be described with reference to the attached drawings:

In the following embodiments, content may mean data in text format used to enable a chatbot to perform a question and answer with a user. The content may include, for example, a title area and a body area. In the technical field, content may be used interchangeably with terms such as chatbot content and chatbot data. Alternatively, content may refer to data in text form of a file stored in a cloud storage. For example, content may include the title of the file or the body of the file. In addition, any format that can express the text of the content, such as a web document such as HTML (HyperText Markup Language) or XML (eXtensible Markup Language), is acceptable.

Hereinafter, several embodiments of the present disclosure will be described with reference to the drawings.

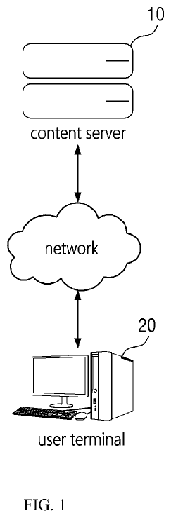

FIG. 1 is an exemplary configuration diagram showing a content search system and a network environment according to an embodiment of the present disclosure.

As shown in FIG. 1, the content search system according to this embodiment includes a user terminal 20 and a content server 10.

The user terminal 20 may transmit the user's content search term to the content server 10 in response to the user's input. The user terminal 20 may receive the results output by the content server 10 in response to the user's input and provide the results to the user.

Here, the content search term may be, for example, a query sentence or a query keyword for performing a query on chatbot content, or a content search term may be a search term entered by the user to search a file stored in a cloud storage. The content search terms may be similarly understood hereinafter and in other parts of the present disclosure.

The content server 10 can perform a search for a plurality of contents. Here, the plurality of contents may be contents stored in the content server 10 or may be contents stored in an external server (not shown). The search may be performed for a plurality of contents using the user's content search term.

According to one embodiment, the content server 10 may receive a plurality of contents from a content server administrator and register them in the database of the content server 10. Here, the plurality of input contents may be, for example, content including a plurality of subfolders uploaded by the user. In this case, the content server 10 may be a cloud storage platform. In addition, the plurality of contents input may be, for example, chatbot contents in the form of text used to perform a question and answer with the user. In this case, the content server 10 may be a chatbot service providing server.

In the process of registering the plurality of contents, the content server 10 may group the plurality of contents, generate grouping information for the plurality of contents, generate index information for the plurality of contents, and calculate a keyword score for each keyword included in the plurality of contents using the grouping information and the index information. The specific calculation method of the keyword score will be described later.

According to one embodiment, the content server 10 may perform a search using a predetermined keyword score for each keyword extracted from the plurality of contents in the process of performing a search for a plurality of contents registered using the obtained content search term.

For example, the content server 10 may divide a plurality of contents into a first content group and a second content group using a predetermined keyword score, extract a first keyword excluding keywords not included in the first content group from the content search term, extract a second keyword excluding keywords not included in the second content group from the content search term to perform a search of the first content group for the first keyword, and perform a search of the second content group for the second keyword. The method for determining keyword scores will be described later.

The content server 10 may calculate the rankings of the first content group and the second content group based on search results for the first content group and the second content group, and provide the search result for the highest-ranked content group based on the calculated rankings to the user terminal 20. The ranking method for each content group will be described later.

According to one embodiment, the content server 10 may obtain a content search term and perform a search for a plurality of registered content. In performing the search, the content server 10 may extract a plurality of search keywords from the content search term. Here, various known algorithms can be used as a keyword extraction method.

According to one embodiment, the content server 10 may register a plurality of contents registered in the database of the content server 10 or the database of an external server (not shown).

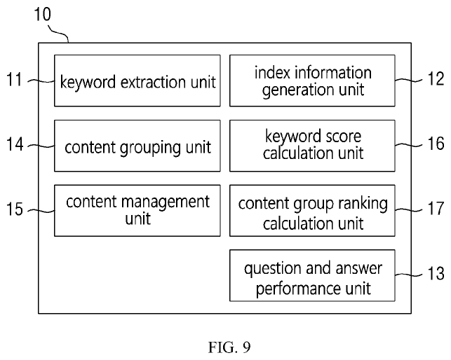

Hereinafter, some embodiments when the content server 10 serves as a chatbot service providing server will be described in detail later with reference to FIGS. 9 to 20.

So far, a content search system and a network environment according to an embodiment of the present disclosure have been described with reference to FIG. 1. The content server 10 and the user terminal 20 may be understood as operating according to a server-client model. However, in some embodiments, the system may be configured in a client stand-alone manner without the need for a server. In this case, the operation performed by the content server 10 may be understood as being performed by the user terminal 20.

Hereinafter, a content search method according to various embodiments of the present disclosure will be described in detail. In order to provide convenience of understanding, the description of the method will be continued assuming the environment shown in FIG. 1, but those skilled in the art will understand that the environment in which the content search method is provided can be modified.

Each step of the methods to be described below may be performed by a computing device. In other words, each step of the above methods may be implemented as one or more instructions executed by a processor of a computing device. All steps included in the methods may be performed by a single physical computing device, or the first steps of the method may be performed by a first computing device and the second steps of the method may be performed by a second computing device. That is, each step of the method may be performed by a computing system. Hereinafter, unless otherwise specified, the description will be continued assuming that each step of the above method is performed by the content server 10 or the user terminal 20. However, for convenience of explanation, the subject of the operation of each step included in the method may be omitted. In addition, the execution order of each operation to be described later can be changed within the range where the execution order can be logically changed as needed.

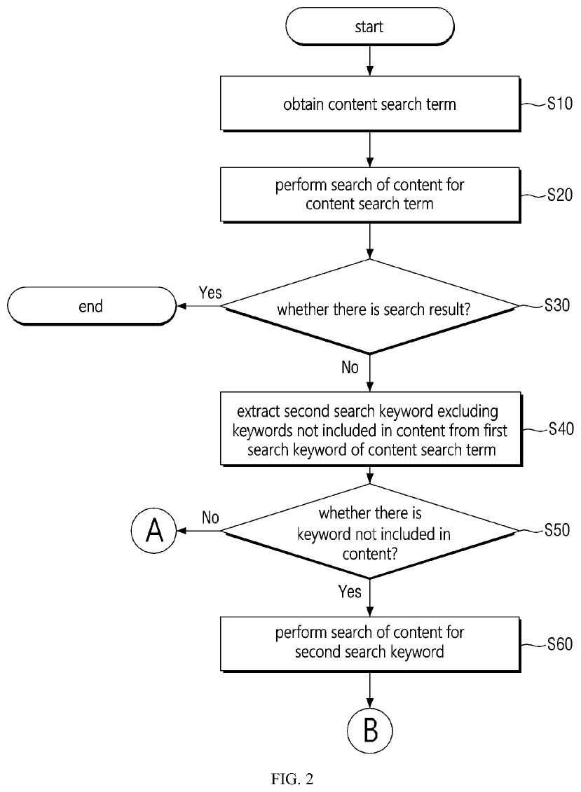

Hereinafter, with reference to FIG. 2, a content search method according to another embodiment of the present disclosure will be described in more detail.

Referring to FIG. 2, a content search term may be obtained from the user in step S10.

According to one embodiment, a content search term may be entered by the user into the user terminal 20 and transmitted to the content server 10.

In step S20, a search for a plurality of contents may be performed using a content search term.

Here, a plurality of search keywords can be extracted from the content search term, and various known keyword extraction algorithms can be used to extract the plurality of search keywords. Hereinafter, it can be understood that various known keyword extraction algorithms can be used to extract keywords in other parts of the present disclosure.

According to one embodiment, a first plurality of search keywords may be extracted from the content search term, and a search for a plurality of contents may be performed using the first plurality of search keywords.

In step S30, it may be determined whether search results for a plurality of contents exist.

As a result of the above determination, if there are search results for a plurality of contents, the search results may be displayed to the user.

As a result of the above determination, if there are no search results for a plurality of contents, a plurality of search keywords excluding keywords not included in the first keyword set may be extracted from the content search term in step S40.

According to one embodiment, when a first plurality of search keywords are extracted from the content search term, a second plurality of search keywords excluding keywords not included in the first keyword set may be extracted from the first plurality of search keywords.

In step S50, it may be determined whether keywords that are not included in the first keyword set exist in the first plurality of search keywords. Here, the first keyword set may be a set of keywords extracted from a plurality of predetermined contents, and various known keyword extraction algorithms may be used to extract keywords from the plurality of contents.

According to one embodiment, the first keyword set may be generated using a method of generating grouping information and index information of content that will be described later with reference to FIGS. 9 to 20.

As a result of the above determination, if there is a keyword that is not included in the first keyword set in the first plurality of search keywords, that is, if a keyword to be excluded exists, first keywords excluding keywords not included in the first keyword set may be extracted from the first plurality of search keywords using a known keyword extraction method, and a search for a plurality of contents may be performed using the first keywords (S60).

According to the above-described embodiments, even if all of the plurality of search keywords extracted from the content search term are not included in the plurality of contents, the user can receive search results by the content server automatically removing the keywords that are not included in the plurality of contents and performing a re-search. Therefore, the user can receive search results without performing unnecessary additional searches. Additionally, search results can be provided to users without registering additional hashtags or synonyms on the content server.

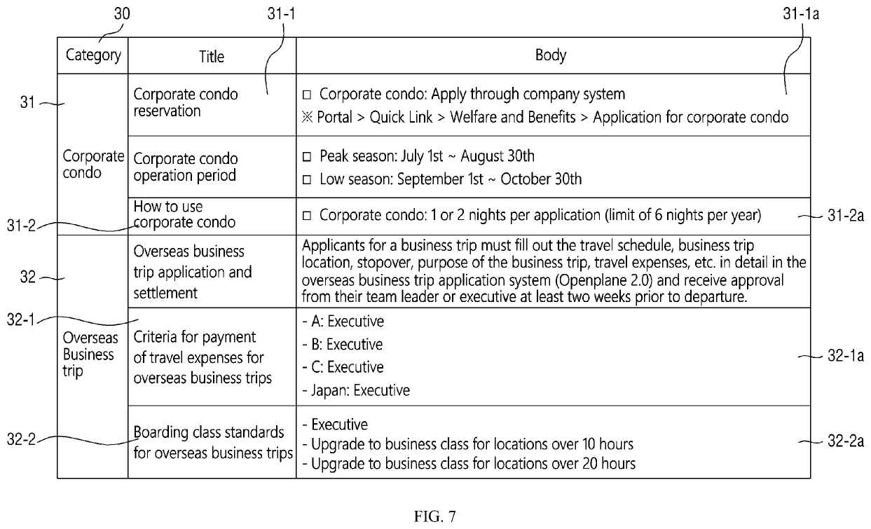

Hereinafter, with reference to FIG. 7, a method of performing a search by excluding keywords not included in the first keyword set from the content search term will be described.

FIG. 7 is a diagram illustrating a plurality of contents that may be referenced in some embodiments of the present disclosure.

Hereinafter, for the first plurality of contents 30 shown in FIG. 7, a search method will be described assuming that the user inputs “I want to reserve a corporate condo at Yeongdeok Training Center” as a content search term.

According to one embodiment, keywords may be extracted from the content search terms entered by the user. In this case, “Yeongdeok,” “Training Center,” “corporate,” “condo,” and “reserve” can be extracted as keywords.

According to one embodiment, keywords that are not included in the first plurality of contents 30 may be excluded from the extracted keywords to extract the second plurality of search keywords. Alternatively, keywords extracted from the first plurality of contents 30 and not included in the predetermined first keyword set may be excluded.

In this case, “Yeongdeok” and “Training Center” are keywords that are not included in the first plurality of contents 30 and can therefore be excluded. Accordingly, “corporate,” “condo,” and “reserve” may be extracted as the second plurality of search keywords.

A search for the first plurality of contents 30 may be performed again using the extracted second plurality of search keywords.

In this case, “corporate condo reserve” content 31_1 can be searched.

The user may receive content 31_1a corresponding to the content 31_1 searched from the content server 10.

According to the above-described embodiments, even if all of the plurality of search keywords extracted from the content search term are not included in the plurality of contents, the user can receive search results by the content server automatically removing the keywords that are not included in the plurality of contents and performing a re-search. Therefore, the user can receive search results without performing unnecessary additional searches. Additionally, search results can be provided to the user without registering additional hashtags or synonyms on the content server.

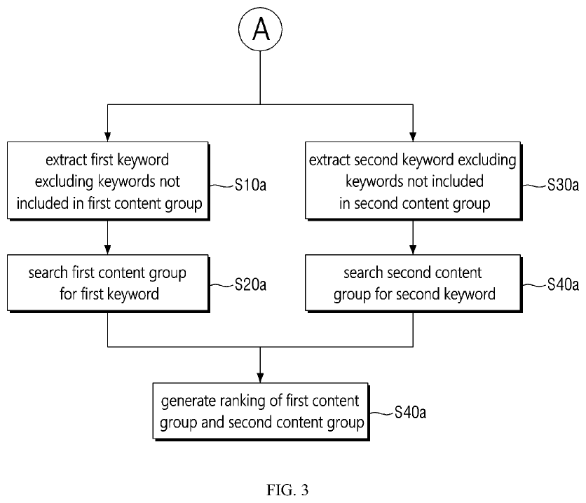

Referring again to FIG. 2, as a result of the determination in step S50, there are no keywords that are not included in the first keyword set in the first plurality of search keywords, that is, there are no keywords to be excluded from the first plurality of search keywords. The keyword search method in a such case will be described in detail with reference to FIG. 3.

Referring to FIG. 3, first keywords excluding keywords not included in the first content group may be extracted from the first plurality of search keywords (S10a), and a second keyword excluding the keyword not included in the second content group may be extracted from the first plurality of search keywords (S30a).

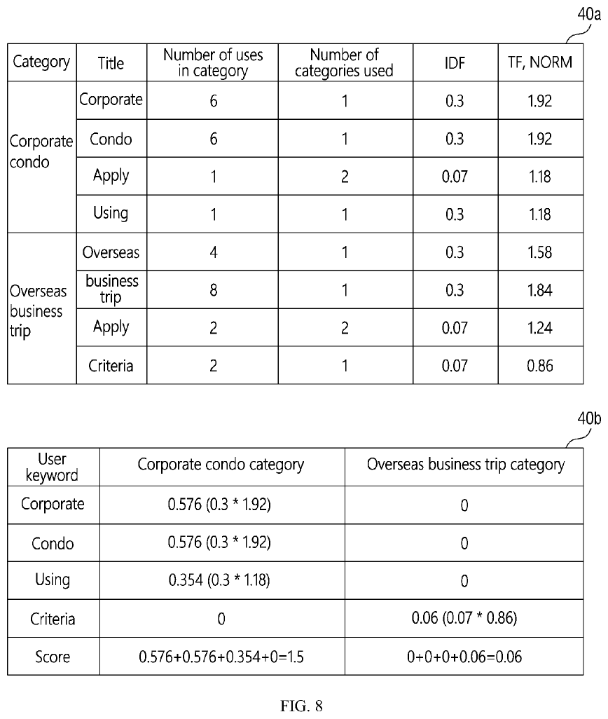

Here, the first content group and the second content group may refer to content groups, in which a plurality of contents are grouped and distinguished. At this time, the grouping method may use the grouping information and index information generation method that will be described later with reference to FIGS. 8 to 19.

According to one embodiment, a search for the first content group may be performed using the extracted first keyword (S20a), and a search for the second content group may be performed using the extracted second keyword (S40a).

In step S50a, the score of the first content group may be calculated using the search result for the first content group in step S20a, and the score of the second content group may be calculated using the search result for the second content group in step S40a, and the rankings of the first content group and the second content group may be calculated based on the score of the first content group and the score of the second content group.

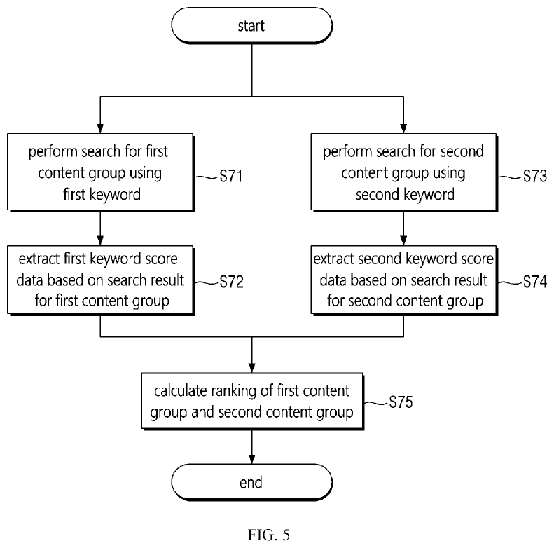

According to one embodiment, search results for the highest-ranked content group may be provided to the user based on the calculated rankings. Hereinafter, the content group ranking calculation method in step S50a will be described with reference to FIG. 5.

FIG. 5 is a flowchart of a content group ranking calculation method that may be referenced in some embodiments of the present disclosure.

Referring to FIG. 5, first, a search for the first content group may be performed using the extracted first keyword (S71), and a search for the second content group may be performed using the extracted second keyword (S73).

In step S72, first keyword score data corresponding to a search result of the first content group for the first keyword may be extracted from the predetermined keyword score data, and in step S74, second keyword score data corresponding to a search result of the second content group for the second keyword may be extracted from the predetermined keyword score data.

In step S75, the rankings of the first content group and the second content group may be calculated using the first keyword score data and the second keyword score data.

According to one embodiment, keyword score data may be data including keywords included in each content group and scores matching the keywords included in each content group.

According to one embodiment, by calculating the rankings of the first content group and the second content group, it is possible to numerically identify which content group meets the user's content search intention.

Hereinafter, with reference to FIGS. 7 and 8, with respect to the first plurality of contents 30, assuming that the user inputs “Tell me the criteria for using a corporate condo” as a content search term, a content search method and a content group ranking calculation method according to another embodiment of the present disclosure will be described.

According to one embodiment, keywords may be extracted from a content search term entered by the user. In this case, “corporate,” “condo,” “using,” and “criteria” can be extracted as keywords.

According to one embodiment, it may be determined whether keywords that are not included in the first plurality of contents 30 exist in the extracted keywords. In this case, since the “corporate,” “condo,” “using,” and “criteria” keywords are all included in the first plurality of contents 30, as a result of the determination, it may be determined that keywords not included in the first plurality of contents 30 do not exist.

If it is determined that keywords that are not included in the first plurality of contents 30 do not exist, the keywords for each of the first content group 31 and the second content group 32 can be extracted from the first plurality of contents 30. Here, the first plurality of contents 30 may be content data grouped and generated by a method of generating content grouping information and index information that will be described later with reference to FIGS. 9 to 20. For example, data of the ‘category’ of the first plurality of contents 30 may be generated using content grouping information, and data of ‘title’ of the first plurality of contents 30 may be generated using index information.

According to one embodiment, the keyword of the first content group 31 may be extracted from the index information (title) of the first content group 31. For example, keywords “corporate,” “condo,” and “using” can be extracted. That is, the first keywords (“corporate,” “condo,” and “using”) excluding “criteria,” which is a keyword not included in the first content group 31, can be extracted.

According to one embodiment, keywords of the second content group 32 may be extracted from index information of the second content group 32. For example, “criteria” keywords can be extracted. That is, the second keyword (“criteria”) excluding “corporate,” “condo,” and “using,” which are keywords not included in the second content group 32, can be extracted.

According to one embodiment, a search for the first content group 31 may be performed using the extracted first keyword, and a search for the second content group 32 may be performed using the extracted second keyword.

For example, a search result 31_2 for the first content group 31 may be derived using the extracted first keyword, and search results 32_1 and 32_2 for the second content group 32 may be derived using the extracted second keyword.

Hereinafter, a method for calculating content group rankings using each extracted search result will be described with reference to the exemplary keyword score data 40a and the extracted keyword score data 40b for each content group shown in FIG. 8.

According to one embodiment, the keyword score data 40a is data resulting from calculating keyword scores matching the first content group and calculating keyword score data matching the second content group, and may be data stored in the content server 10.

According to one embodiment, the extracted keyword score data 40b for each content group may be that the resulting data as a score for each keyword included in the first keyword is calculated based on the result of a search for the first content group using the first keyword is presented visually.

In this case, 0.576 points are calculated for the “corporate” keyword, 0.576 points are calculated for the “condo” keyword, and 0.354 points are calculated for the “using” keyword. 1.5 points are calculated for the first content group, which is the sum of the scores matching each keyword.

In the same way, a score for each keyword included in the second keyword is calculated based on the results of a search for the second content group using the second keyword.

In this case, 0.06 points are calculated for the “criteria” keyword, and finally 0.06 points are calculated for the second content group.

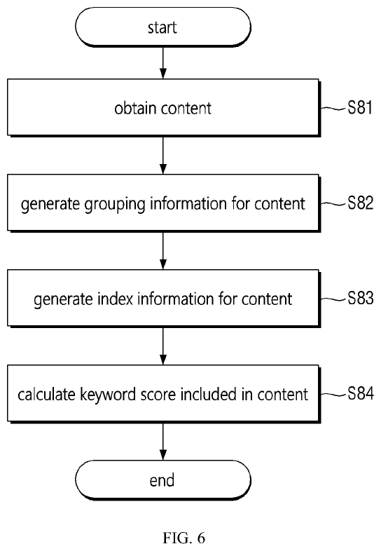

In this case, the BM25 algorithm can be used to calculate the score for each keyword, and will be described again with reference to FIG. 6 later.

According to one embodiment, the rankings of the first content group and the second content group may be calculated using the score data of the first content group and the score data of the second content group.

In this case, since the first content group has the highest ranking with a score of 1.5 points, a search result 31_2a for the first content group may be presented to the user. In other words, the text “Corporate condo: 1 or 2 nights per application (limit of 6 nights per year)” (31_2a) may be presented to the user.

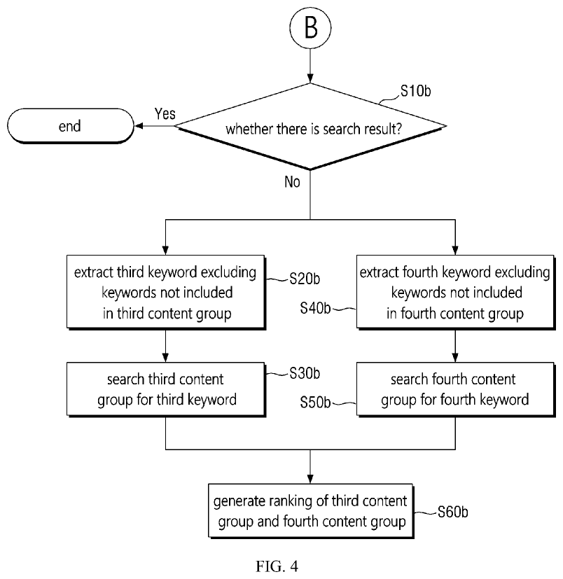

Referring again to FIG. 2, in step S60, a search of content for the first search keyword may be performed. Here, a content search method when the search results do not exist will be described with reference to FIG. 4.

Referring to FIG. 4, first, it is determined whether the search result exists (S10b).

If there is no search result as a result of the determination, a third keyword excluding keywords not included in the third content group may be extracted from the second plurality of search keywords (S20b), and a fourth keyword excluding keywords not included in the fourth content group may be extracted from the second plurality of search keywords (S40b).

Here, the third content group and the fourth content group may refer to content groups, in which a plurality of contents are grouped and distinguished. At this time, the grouping method may use the grouping information and index information generation method that will be described later in FIGS. 9 to 20, and the extraction method of the third and fourth keywords may use various existing known keyword extraction methods.

According to one embodiment, a search for the third content group may be performed using the extracted third keyword (S30b), and a search for the fourth content group may be performed using the extracted fourth keyword (S50b).

In step S60b, the score of the third content group may be calculated using the search result for the third content group in step S30b, and the score of the fourth content group may be calculated using the search result for the fourth content group in step S50b, and the rankings of the third content group and the fourth content group may be calculated based on the score of the third content group and the score of the fourth content group.

According to one embodiment, search results for the highest-ranked content group may be provided to the user based on the calculated rankings. As a method for calculating the ranking of a content group, the method previously described with reference to FIGS. 3, 7, and 8 may be applied in the same manner.

According to the above-described embodiments, as a search is performed by each content group for a plurality of search keywords extracted from the content search term, and the rankings of the search results for each content group are calculated, the user receives search results for the highest-ranked content group, so search results that best match the user's intent can be received. Accordingly, the user can receive search results without performing unnecessary additional searches. Additionally, search results that match the user's intent can be provided to the user without registering additional hashtags or synonyms being on the content server.

FIG. 6 is a flowchart of a content registration method according to another embodiment of the present disclosure.

In step S81, a plurality of contents may be obtained.

According to one embodiment, a plurality of contents may be transmitted from the administrator of the content server 10 to the content server 10 and obtained.

In step S82, grouping information for a plurality of obtained contents may be generated.

According to one embodiment, the grouping information may be grouping information generated based on the calculated similarity between contents included in the plurality of obtained contents. Here, the similarity calculation method that will be explained later in FIGS. 9 to 20 may be used.

In step S83, index information may be generated by mapping keywords extracted from a plurality of contents and content titles included in the plurality of contents. Here, the index information generation method that will be described later with reference to FIGS. 9 to 20 may be used.

In step S84, a keyword score for each keyword included in a plurality of contents may be calculated using the grouping information and the index information.

Here, the BM25 algorithm based on [Equation 1] and [Equation 2] below can be used as a keyword score calculation method.

$$score ( D , Q ) = {\sum }_{i = 1}^{n} IDF ( {q}_{i} ) \cdot \frac{f ( {q}_{i} , D ) \cdot ( {k}_{1} + 1 )}{f ( {q}_{i} , D ) + {k}_{1} \cdot ( 1 - b + b \cdot \frac{\vert D \vert}{avgdl} )} , \qquad [ Equation 1 ]$$

$$IDF = log ( 1 + \frac{docCount - docFreq + 0.5}{docFreq + 0.5} ) \qquad [ Equation 2 ]$$

In [Equation 1], the input value D is an input document and may be a plurality of contents, and the input value Q may be a search query including keywords included in a plurality of contents, and may be a search query including a single or multiple keywords. For example, the input value Q may be a first plurality of search keywords extracted from content search terms input by the user, and may be a second plurality of search keywords excluding keywords not included in the first keyword set extracted from the first plurality of search keywords. Here, qᵢ may be the ith keyword of the search query (Q).

Here, the b value is a NORM weight value and can be selected, for example, as 0.75, and the k1 value is a TF (Term Frequency) weight value and can be selected, for example, as 1.2 or 2.0.

In [Equation 2] above, docCount may refer to the total number of content groups included in a plurality of contents, and docFreq may refer to the number of content groups used to calculate the score.

According to the above-described embodiments, when a plurality of contents are obtained and registered in a content server, the score of each keyword included in the plurality of contents is calculated, and in a content search for a plurality of contents, search results that match the user's intent can be provided by using the keyword score.

Chatbot Content Search Method for Providing a Chatbot Service

This section describes chatbot content search method for providing chatbot services.

Hereinafter, with reference to FIGS. 9 to 20, a chatbot content search method for providing a chatbot service according to some embodiments of the present disclosure will be described. Hereinafter, it is assumed that the content server 10 is a chatbot service providing server.

FIG. 9 is an example block diagram for describing a chatbot service providing server according to another embodiment of the present disclosure.

The chatbot service providing server 10 may comprise a keyword extraction unit 11, an index information generation unit 12, a question and answer performance unit 13, a content grouping unit 14, a content management unit 15, a keyword score calculation unit 16, and a content group ranking calculation unit 17.

The keyword extraction unit 11 may extract keywords from a plurality of contents. The method for extracting keywords will be described later.

The index information generation unit 12 may generate index information for a plurality of contents. Here, the index information may be information that maps keywords included in the plurality of contents and titles of the plurality of contents. Additionally, the chatbot service server 10 may obtain a content list corresponding to keywords included in the user query based on the generated index information.

According to one embodiment, the index information may be generated and stored in the content management unit 15.

The content grouping unit 14 may group the plurality of contents based on the similarity between each content included in the plurality of contents.

According to one embodiment, a plurality of grouping contents may be stored in the content management unit 15.

The content grouping unit 14 may calculate the degree of similarity between contents included in a plurality of contents. Here, the similarity between the contents can be calculated based on the frequency, in which each keyword extracted from the content is included in the content. The method of calculating similarity will be described in detail later.

The content management unit 15 may store a plurality of the grouped contents.

According to one embodiment, chatbot content may be registered and stored in the content management unit 15 of the chatbot service providing server 10 by the chatbot administrator.

According to one embodiment, the keyword score of each keyword included in a plurality of registered contents provided from the keyword score calculation unit 16 may be stored in the content management unit 15.

The question and answer performance unit 13 may provide a chatbot service using the grouping information and the index information. Here, the chatbot service may mean providing responses to a query input from the user terminal 20.

According to one embodiment, the question and answer performance unit 13 may receive a query from a chatbot (device) that has received a query from a chatbot user and perform a search for the query.

A detailed method of providing the chatbot service will be described later.

When there is a request from the content management unit 15 to calculate keyword scores included in a plurality of contents, the keyword score calculation unit 16 may calculate the keyword score of each keyword included in the plurality of contents using the index information of the plurality of contents generated based on the plurality of contents by the index information generation unit 12 and the grouping information of the plurality of contents generated based on the plurality of contents by the content grouping unit 14.

According to one embodiment, the keyword score calculation unit 16 may provide the calculated keyword score to the content management unit 15.

The content group ranking calculation unit 17 may calculate rankings for the plurality of grouped contents when there is a request for ranking calculation for the plurality of grouped contents from the question and answer performance unit 13. The method previously described based on FIGS. 5, 7, and 8 can be applied in the same way as the ranking calculation method for a plurality of grouped contents.

So far, the configuration and operation of the chatbot service providing server 10 has been described with reference to FIG. 9. The chatbot service providing server 10 and the user terminal 20 may be understood as operating according to the server-client model. However, in some embodiments, the system may be configured in a client stand-alone manner without the need for a server. In this case, the operation performed by the chatbot service providing server 10 may be understood as being performed by the user terminal 20.

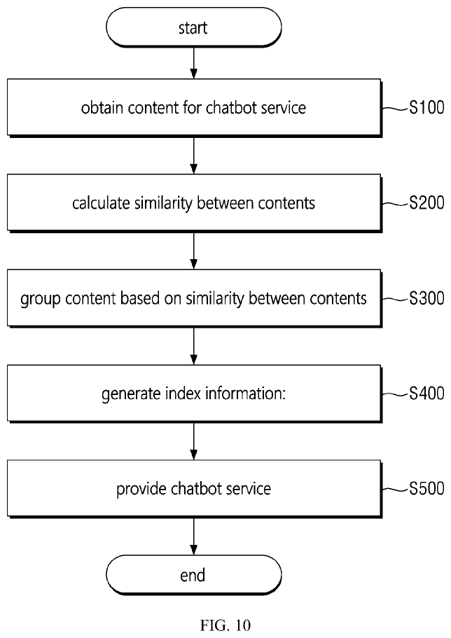

Hereinafter, with reference to FIGS. 10 to 20, a chatbot service providing method according to another embodiment of the present disclosure will be described in more detail. Hereinafter, the steps to be described in several flowcharts may be understood as being performed by the chatbot service providing server 10, unless otherwise specified.

FIG. 10 is a flowchart of a chatbot service providing method according to the present embodiment.

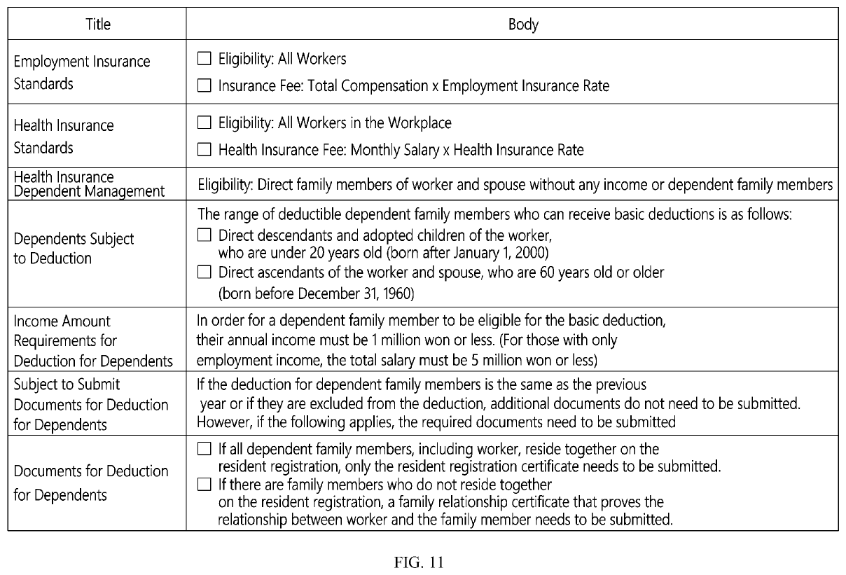

In step S100 shown in FIG. 10, the chatbot service providing server 10 may obtain a plurality of contents for the chatbot service from the administrator. For a more detailed description of the plurality of contents, FIG. 11 will be referenced.

Referring to FIG. 11, the plurality of contents may be composed of, for example, a content title and content body. However, the scope of the present disclosure is not limited thereto.

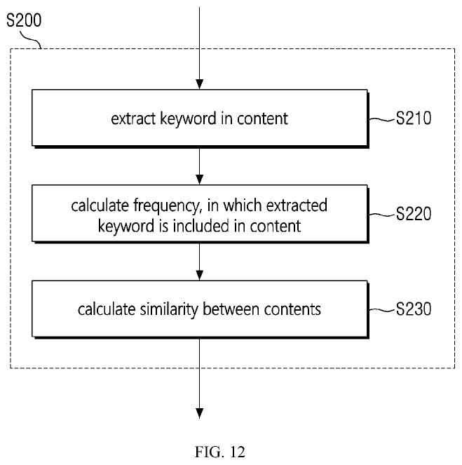

Next, in step S200, the chatbot service providing server may calculate the degree of similarity between the plurality of obtained contents. In order to explain the step of calculating the similarity in more detail, it will be described with reference to FIGS. 12 to 15.

In step S210 shown in FIG. 12, the chatbot service providing server 10 may extract keywords included in the content. Here, the keyword may mean, for example, a morpheme whose part of speech is a noun in the title and body of the content.

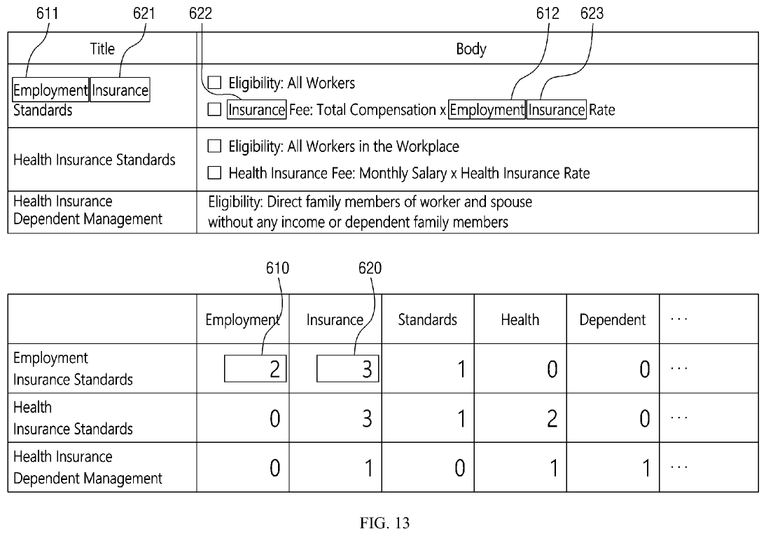

In some embodiments related to step S210, in order to perform the step of extracting the keyword, the chatbot service providing server 10 may perform morphological analysis on the title and body of the content. More specifically, the keyword extraction unit 110 of the chatbot service providing server 10 may extract morphemes whose parts of speech are nouns through morpheme analysis of the title and body of the content. Referring to FIG. 13, the keyword extraction step S210 will be described in more detail.

Referring to FIG. 13, for example, in the title (‘Employment Insurance Standards’) and body of the ‘Employment Insurance Standards’ content, since ‘employment’ morphemes 611, 612 and ‘insurance’ morphemes 621-623 correspond to nouns, they can be extracted as a keyword by the chatbot service providing server 10.

Next, in step S220, the chatbot service providing server 10 may calculate the frequency, in which the extracted keyword is included in the content. For example, referring to FIG. 13, there are a total of 2 ‘employment’ keywords included in the title and body of the ‘Employment Insurance Standards’ content, so the frequency of the ‘employment’ keyword being included in the content can be calculated as 2.

In some embodiments related to step S220, the chatbot service providing server 10 may generate a keyword vector for each content based on the frequency, in which the extracted keyword is included in each content. The step of generating the keyword vector will be described in more detail with reference to FIG. 13.

For example, referring to FIG. 13, the 1st row, 1st column element of the keyword vector may be the frequency 610, in which the ‘employment’ keyword is included in the ‘Employment Insurance Standards’ content. Likewise, the 1st row, 2nd column element may be the frequency 620, in which the ‘insurance’ keyword is included in the ‘Employment Insurance Standards’ content. In this way, the keyword vector may be a vector whose elements include the frequency, in which each extracted keyword is included for each content.

Next, in step S230, the chatbot service providing server 10 may calculate the degree of similarity between contents based on the frequency, in which the calculated keyword is included in the contents. The step of calculating the similarity will be described in more detail with reference to FIG. 7.

In some embodiments related to step S230, the chatbot service providing server 10 may calculate the similarity for all content pairs among the plurality of contents. The similarity may have the form of a real number between 0 and 1.

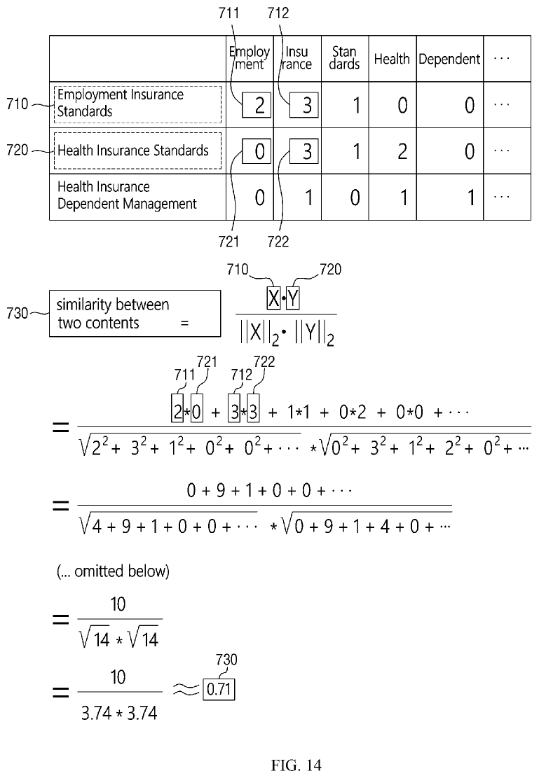

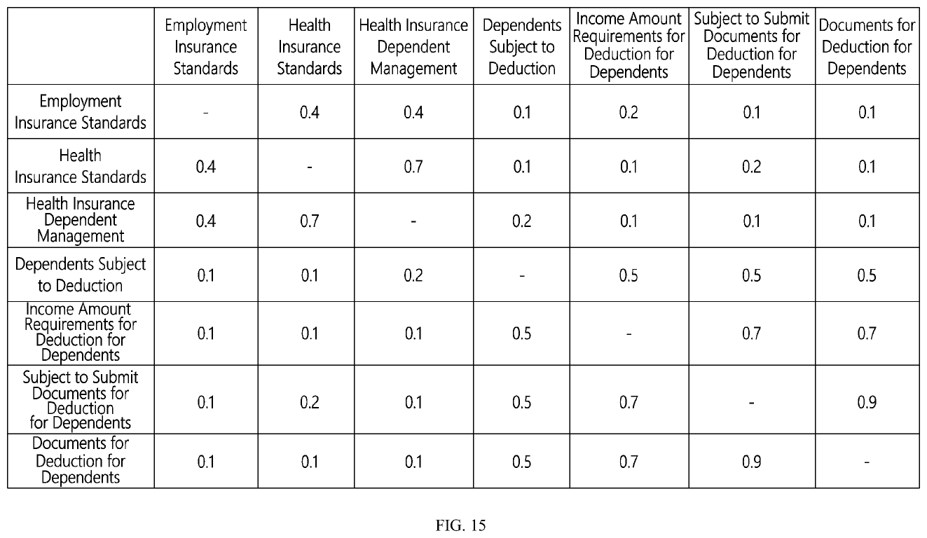

For example, when the chatbot service providing server 10 receives three contents, referring to the table in FIG. 14, the similarity between the ‘Employment Insurance Standards’ content and the ‘Health Insurance Standards’ content, the similarity between the ‘Employment Insurance Standards’ content and the ‘Health Insurance Dependent Management’ content and the similarity between the ‘Health Insurance Standards’ content and the ‘Health Insurance Dependent Management’ content can all be calculated. The results of the step of calculating the similarity for the content pair can be clearly understood with reference to FIG. 15.

In some embodiments related to step S230, the chatbot service providing server 10 may calculate the similarity of the content pair based on cosine similarity. A method of calculating using cosine similarity will be described with reference to FIG. 14.

Referring to FIG. 14, the similarity 730 between two contents may be calculated using the calculation formula (i.e., cosine similarity) shown in FIG. 14. To help understand this disclosure, an example of calculating the similarity between the ‘Employment Insurance Standards’ content 710 and the ‘Health Insurance Standards’ content 720 will be explained. In the calculation formula of FIG. 14, the variable X may refer to a keyword vector for the content related to the ‘Employment Insurance Standards,’ and the variable Y may refer to a keyword vector for the content related to the ‘Health Insurance Standards.’

As illustrated by the ‘employment’ keyword in FIG. 14, the value obtained by multiplying the frequency, in which the keyword corresponding to the 1st column of the keyword vector is included in the ‘Employment Insurance Standards’ content 711, and the frequency, in which the keyword is included in the ‘Health Insurance Standards’ content 721, and as illustrated by the ‘insurance’ keyword, the value obtained by calculating the frequency, in which the keyword corresponding to the 2nd column of the keyword vector is included in the ‘Employment Insurance Standards’ content 712, and the frequency, in which the keyword is included in the ‘Health Insurance Standards’ content 722, are added together. In addition, the same operation is performed on the elements of other keyword vectors below. As a result of performing this task, the similarity 730 between the ‘Employment Insurance Standards’ content and the ‘Health Insurance Standards’ content can be calculated.

In other words, when there are N keywords extracted from the input content, the value of the numerator of the calculation formula can be obtained by calculating the equation K₁*L₁+K₂*L₂+ . . . +Kₙ*Lₙ for the frequency K, in which each keyword is included in the first content of the content pair to be calculated, and the frequency L, in which each keyword is included in the second content of the content pair to be calculated.

In addition, the denominator value of the above calculation formula can be obtained by calculating the equation \sqrt{K₁²+K₂²+K₃²+ . . . +\sqrt{Kₙ²}+L₁²+L₂²+L₃²+ . . . +Lₙ²}.

According to this embodiment, the similarity between unstructured content consisting of a large amount of text can be accurately calculated as a quantitative value. The similarity between contents expressed in quantitative numbers can be widely applied in other technical fields that utilize text analysis.

So far, the method of calculating the similarity between a plurality of contents by the chatbot service providing server 10 has been described in detail.

The description continues with reference to FIG. 10 again.

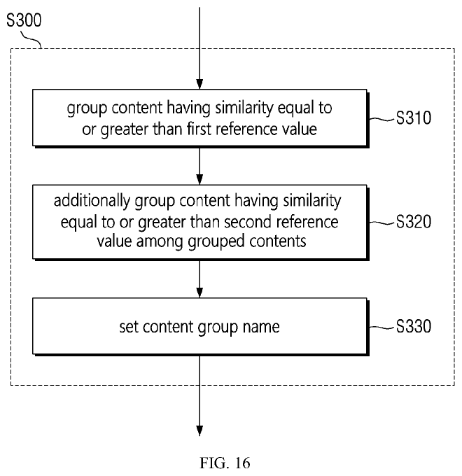

In S300 of FIG. 10, the chatbot service providing server 10 may group a plurality of contents based on the calculated similarity between contents. The step of grouping the plurality of contents will be described in more detail with reference to FIGS. 16 to 18.

Referring to FIG. 16, in step S310, the chatbot service providing server 10 may group content whose similarity is equal to or greater than the first reference value. Here, the first reference value may be predetermined by the administrator or the chatbot service providing server 10.

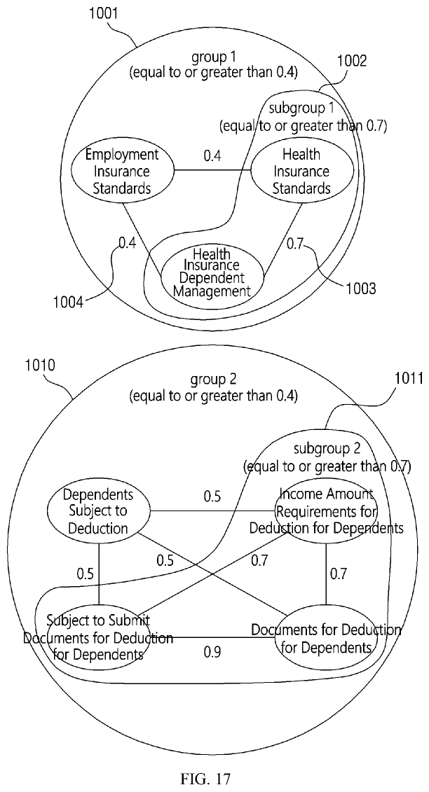

Referring to the table of similarities between contents in FIG. 15 and FIG. 17, for example, when the first reference value is determined to be 0.4, since the similarity between ‘Employment insurance standards’ content, ‘Health insurance standards’ content, and ‘Health insurance dependent management’ content’ is equal to or greater than 0.4, they can be grouped into group 1 (1001). In addition, the similarity between the ‘Dependents eligible for deduction’ content, ‘Income amount requirements for dependents deduction’ content, ‘Subject to submission of documents for dependents deduction’ content, and ‘Documents to be submitted for dependents deduction’ content is greater than or equal to 0.4, so the above contents also can be grouped into group 2 (1010).

Meanwhile, since the similarity between the ‘Employment insurance standards’ content and the ‘Dependents eligible for deduction’ content, ‘Income amount requirements for dependents deduction’ content, the ‘Subject to submission of documents for dependents deduction’ content, and the ‘Documents to be submitted for dependents deduction’ content is less than 0.4, the contents cannot be grouped.

In step S320, the chatbot service providing server 10 may additionally group content whose similarity is greater than or equal to the second reference value among the grouped content. The additional grouping may mean generating a subgroup within the content group to include a plurality of content having a similarity greater than or equal to a second reference value. To clarify the understanding of the present disclosure, hereinafter, the content group that can be obtained as a result of performing step S310 will be referred to as the first content group, and the sub content group of the first content group will be referred to as the second content group.

For example, referring to FIG. 17, in response to determining that the similarity 1003 between the ‘Health insurance standards’ content and the ‘Health insurance dependent management’ content among the contents included in group 1 (1001) is greater than or equal to the second reference value, the chatbot service providing server 10 may group the two contents into subgroup 1 (1002). On the other hand, since the similarity 1004 between the ‘Employment insurance standards’ content and the ‘Health insurance dependent management’ content is not greater than or equal to the second reference value, additional grouping may not be done. At this time, the second reference value may be a value greater than the first reference value.

In some embodiments related to step S320, in response to determining that the number of contents included in the first content group is greater than or equal to a threshold, the chatbot service providing server may automatically group them into the second content group 10 including a portion of the content included in the first content group.

Referring to FIG. 17, assuming that the second reference value for additional grouping of the previously grouped content group 2 (1010) is 0.8, it can be clearly understood that additional grouping of the contents included in group 2 (1010) is not performed through the above explanations. However, assuming that the number of contents corresponding to the threshold is 2, in response to determining that it exceeds the threshold because the number of contents that are not additionally grouped included in the group 2 (1010) is 4, the chatbot service providing server 10 may lower the second reference value to 0.7 and generate subgroup 2 (1011).

Previously, the chatbot administrator had to refine categories in advance and then register chatbot content one by one. However, according to this embodiment, the chatbot administrator only has to register the chatbot content, so the administrator's convenience can be greatly improved.

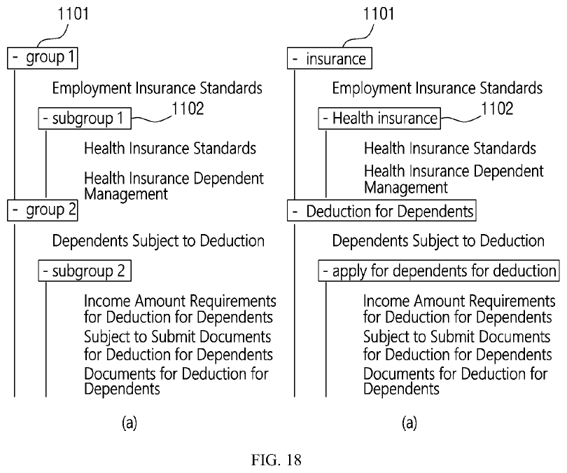

Next, in step S330, the chatbot service providing server 10 may set the names of content groups. The step of setting the names of the content groups will be described in detail with reference to FIG. 18.

In some embodiments related to step S330, the chatbot service providing server 10 may set the names of the content groups based on the input received from the administrator terminal 200. For example, referring to FIG. 18, since the name of group 1 (1101) is ‘insurance’ (1101) by input of the administrator terminal 200, the name of subgroup 1 (1102) can be set to ‘health insurance’ (1102).

In some embodiments related to step S330, the chatbot service providing server 10 may automatically set a group name based on common keywords included in a plurality of contents within the content group. According to this embodiment, the chatbot service providing server 10 can automatically set an appropriate name for the content group even without administrator intervention. Accordingly, the convenience of chatbot administrators can be greatly improved.

So far, the method of grouping a plurality of contents based on the similarity between the plurality of contents by the chatbot service providing server 10 has been described.

The description continues with reference to FIG. 10 again.

In step S400, the chatbot service providing server 10 may generate index information by mapping keywords extracted from a plurality of contents and content titles of each of the plurality of contents. The index information can be used to search content corresponding to the user's input in the step where the chatbot service providing server 10 performs a question and answer with the user, which will be described later.

The operation of mapping the keywords extracted from the plurality of contents and the content title of each content will be explained using an example. For example, assuming that ‘employment’ keyword is extracted from a plurality of contents and that there is content with the title ‘Employment insurance standards,’ in response to determining that the title of the content contains ‘employment’ keyword, the chatbot service providing server 10 may map ‘employment’ keyword and the corresponding content.

User satisfaction with chatbot services largely depends on the ability to quickly provide appropriate responses to user queries. According to this embodiment, the chatbot service providing server 10 can quickly perform content query and quickly provide a response based on index information, thereby achieving the effect of maximizing the satisfaction of chatbot service users.

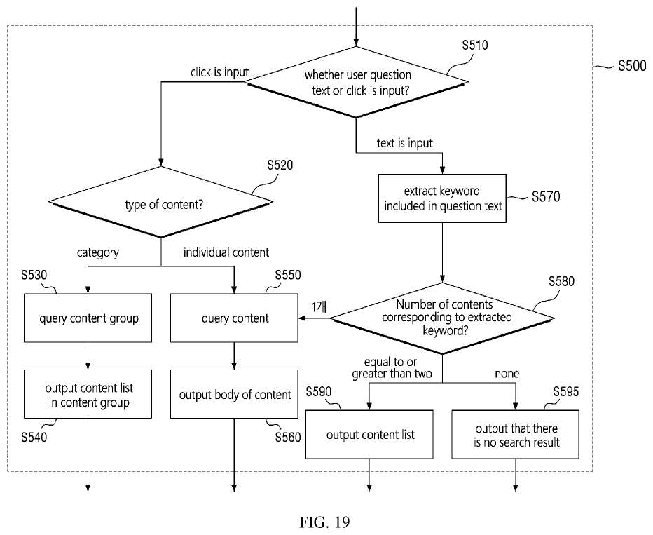

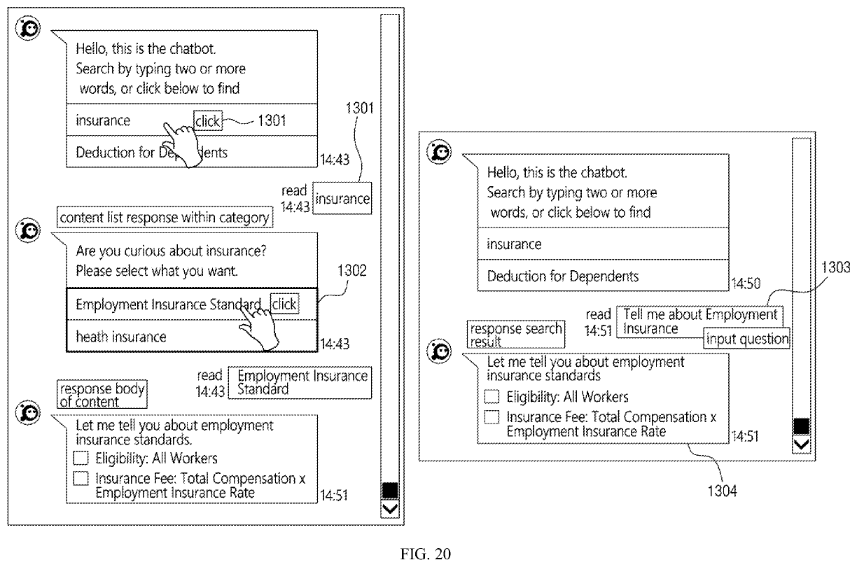

In step S500, the chatbot service providing server 10 may provide a chatbot service to the user. Here, provision of the chatbot service may mean that the chatbot service providing server 10 performs a question and answer with the chatbot service user. The steps for providing a chatbot service will be described in more detail with reference to FIGS. 19 and 20.

Referring to FIG. 19, in step S510, the chatbot service providing server 10 may evaluate the type of input corresponding to the user's query from the user terminal. The form of input corresponding to the user's query may be text input or mouse input.

In step S520, in response to a determining that the form of the user input corresponds to a click input for a pre-provided list (e.g., a list listing content titles, a list listing names of content groups, etc.), the chatbot service providing server 10 can evaluate the type of content (item) clicked on in the list. The type of content may be, for example, a content group (i.e., category) or specific content.

In step S530, the chatbot service providing server 10 may search for contents belonging to the content group in response to a determining that the type of content clicked corresponds to a content group. Furthermore, in step S540, the chatbot service providing server 10 may output a list of the searched contents. The list of output contents may be displayed by a display device provided in the user terminal.

In some embodiments related to step S530, referring to FIG. 20, in response to determining that the type of content corresponding to the user's click input 1301 for the ‘insurance’ keyword corresponds to a content group, the chatbot service providing server 10 may provide the ‘Employment insurance standards’ content and the ‘Health insurance standards’ content included in the content group 1302 associated with the ‘insurance’ keyword to the user in the form of a list.

Here, as shown in FIG. 20, the ‘insurance’ keyword clicked by the user is displayed in the form of a dialog box 1301 containing the ‘insurance’ text in the dialogue window for performing a question and answer between the user and the chatbot within the display device of the user terminal, just as the user entered the text.

In step S550, in response to a determining that the type of content corresponding to the user input corresponds to a specific content, the chatbot service providing server 10 may query the title and body of the content corresponding to the user input. Furthermore, in step S560, the chatbot service providing server 10 may output the body of the searched content. The body of the output content may be displayed by a display device provided in the user terminal.

In some embodiments related to step S550, referring to FIG. 20, in response to determining that the user's input corresponds to the ‘Employment insurance standards’ content in a content list 1302 including the ‘Employment insurance standards’ content and ‘Health insurance standards’ content, the chatbot service providing server 10 may query the title and body of the ‘Employment insurance standards’ content. Next, the chatbot service providing server 10 may output the body of the ‘Employment insurance standards’ content searched above.

Next, in step S570, in response to a determining that the form of the user input corresponds to a text input (i.e., a query), the chatbot service providing server 10 may extract keywords included in the user query. The operation of extracting keywords can be clearly understood by referring to descriptions related to some embodiments of step S210 above.

For example, referring to FIG. 20, the chatbot service providing server 10 may extract ‘employment’ and ‘insurance’, which have noun parts of speech, as keywords included in the user's query from ‘Tell me about employment insurance’ text 1303 in the user query.

In step S580, the chatbot service providing server 10 may determine whether the number of contents searched using the extracted keyword is plural. The content search can be performed through pre-generated index information.

According to some embodiments of the present disclosure, in response to determining that the number of searched contents is one, the chatbot service providing server 10 may output the body of the searched content as a response.

For example, referring to FIG. 20, in response to determining that the number of contents searched with the keyword extracted from the user query 1303 is one, the chatbot service providing server 10 may output the body of the searched ‘Employment insurance standards’ content 1304.

In step S590, in response to determining that the number of searched contents is two or more, the chatbot service providing server 10 may output the searched contents in the form of a list.

In step S595, in response to determining that the content searched with the extracted keyword does not exist, the chatbot service providing server 10 may provide a message indicating that there are no search results as a response.

So far, the chatbot service providing method according to an embodiment of the present disclosure has been described in detail.

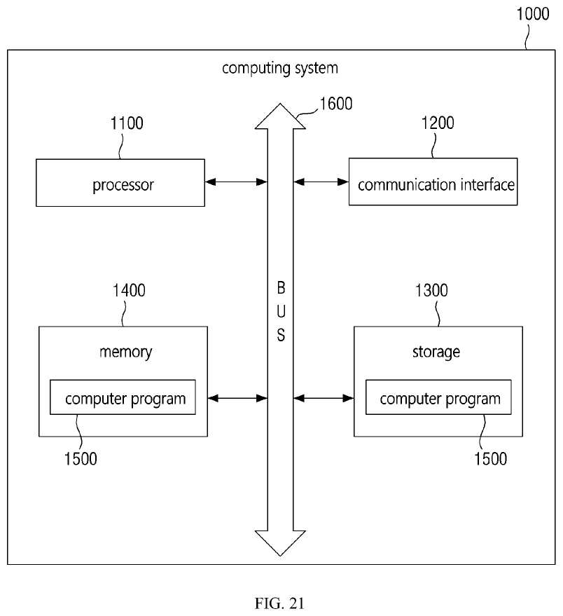

FIG. 21 is a hardware configuration diagram of a computing system according to some embodiments of the present disclosure. The computing system 1000 shown in FIG. 21 may refer to, for example, a computing system including the content server 10 described with reference to FIG. 1 and may refer to a computing system including the user terminal 20. The computing system 1000 may comprise one or more processors 1100, a system bus 1600, a communication interface 1200, a memory 1400 that loads a computer program 1500 executed by the processor 1100, and a storage 1300 that stores a computer program 1500.

The processor 1100 controls the overall operation of each component of the computing system 1000. The processor 1100 may perform operations on at least one application or program to execute methods/operations according to various embodiments of the present disclosure. The memory 1400 stores various data, commands and/or information. The memory 1400 may load one or more computer programs 1500 from the storage 1300 to execute methods/operations according to various embodiments of the present disclosure. The bus 1600 provides communication functions between components of computing device 1000. The communication interface 1200 supports internet communication of the computing system 1000. The storage 1300 may non-temporarily store one or more computer programs 1500. The computer program 1500 may include one or more instructions implementing methods/operations according to various embodiments of the present disclosure. When the computer program 1500 is loaded into the memory 1400, the processor 1100 can perform methods/operations according to various embodiments of the present disclosure by executing the one or more instructions.

In some embodiments, the computer program 1500 may perform operations comprising obtaining a content search term, performing a search for a plurality of contents using a first plurality of search keywords included in the content search term, extracting, when there is no result of the search, a second plurality of search keywords excluding keywords not included in a first keyword set from the first plurality of search keywords, and performing a search for the plurality of contents using the second plurality of search keywords.

So far, various embodiments of the present disclosure and effects according to the embodiments have been described with reference to FIGS. 1 to 21. Effects according to the technical spirit of the present disclosure are not limited to the effects mentioned above, and other effects not mentioned will be clearly understood by those skilled in the art from the description below.

The technical idea of the present disclosure described so far may be implemented as computer readable code on a computer readable medium. The computer program recorded on the computer-readable recording medium may be transmitted to another computing device through a network such as the Internet, installed in the other computing device, and thus used in the other computing device.

Although operations are shown in a particular order in the drawings, it should not be understood that the operations should be performed in the specific order shown or in a sequential order, or that all shown operations should be performed to obtain a desired result. In certain circumstances, multitasking and parallel processing may be advantageous. Although the embodiments of the present disclosure have been described with reference to the accompanying drawings, those of ordinary skill in the art to which the present disclosure pertains can understand that the present invention can be practiced in other specific forms without changing the technical spirit or essential features. Therefore, it should be understood that the embodiments described above are illustrative in all respects and not limiting. The protection scope of the present invention should be construed by the claims below, and all technical ideas within the equivalent range should be construed as being included in the scope of the technical ideas defined by the present disclosure.

What is claimed is:

1. A method performed by at least one processor, the method comprising:
obtaining a content search term, the content search term including a first plurality of search keywords;
performing a search for a plurality of contents using the first plurality of search keywords;
extracting, based on no result of the search, a second plurality of search keywords from the first plurality of search keywords, wherein the second plurality of search keywords exclude keywords that are not included in a first keyword set, and the first keyword set includes keywords extracted from the plurality of contents; and
performing a search for the plurality of contents using the second plurality of search keywords.

2. The method of claim 1, further comprising, based on there being no keyword that is not included in the first keyword set in the content search term:
extracting a first keyword excluding keywords not included in a first content group from the second plurality of search keywords, and extracting a second keyword excluding keywords not included in a second content group from the second plurality of search keywords, wherein the first content group and the second content group are groups of contents included in the plurality of contents; and
performing a search for the first content group using the first keyword and performing a search for the second content group using the second keyword.

3. The method of claim 2, further comprising:
determining rankings of the first content group and the second content group based on search results for the first content group and the second content group; and
providing a search result for a highest-ranked content group based on the determined rankings.

4. The method of claim 3, wherein the determining the rankings comprises:
extracting, from predetermined keyword score data, first keyword score data corresponding to a result of the search for the first content group using the first keyword;
extracting, from the predetermined keyword score data, second keyword score data corresponding to a result of the search for the second content group using the second keyword; and
determining the rankings of the first content group and the second content group using the first keyword score data and the second keyword score data,
wherein the predetermined keyword score data comprise keywords included in each content group and scores matching the keywords included in each content group.

5. The method of claim 4, wherein the first keyword score data and the second keyword score data are data determined using a BM25 algorithm.

6. The method of claim 1, further comprising, based on there being no result of the search using the second plurality of search keywords:
extracting a third keyword excluding keywords not included in a third content group from the second plurality of search keywords, and extracting a fourth keyword excluding keywords not included in a fourth content group from the second plurality of search keywords,
wherein the third content group and the fourth content group are groups of contents included in the plurality of contents; and
performing a search for the third content group using the third keyword, and performing a search for the fourth content group using the fourth keyword.

7. The method of claim 6, further comprising:
determining rankings of the third content group and the fourth content group based on search results for the third content group and the fourth content group; and
providing a search result for a highest-ranked content group based on the determined rankings.

8. The method of claim 7, wherein the determining the rankings comprises:
extracting, from predetermined keyword score data, third keyword score data corresponding to a result of the search for the third content group using the third keyword;
extracting, from the predetermined keyword score data, fourth keyword score data corresponding to a result of the search for the fourth content group using the fourth keyword; and
determining the rankings of the third content group and the fourth content group using the third keyword score data and the fourth keyword score data,
wherein the third or fourth keyword score data comprise keywords included in the third or fourth content group and scores matching the keywords included in the third or fourth content group.

9. The method of claim 8, wherein the third keyword score data and the fourth keyword score data are data determined using a BM25 algorithm.

10. The method of claim 1, wherein the plurality of contents are chatbot content, and
wherein the content search term is a query entered by a user.

11. The method of claim 1, further comprising, prior to the obtaining the content search term:
registering the plurality of contents,
wherein the registering the plurality of contents comprises:
grouping the plurality of contents to generate grouping information for the plurality of contents;
generating index information for the plurality of contents; and
determining keyword scores for the plurality of contents using the grouping information and the index information and storing the keyword scores in a database.

12. A method performed by at least one processor, the method comprising:
obtaining a plurality of contents;
grouping the plurality of contents to generate grouping information for the plurality of contents;
generating index information for the plurality of contents; and
determining a keyword score for each keyword included in the plurality of contents using the grouping information and the index information.

13. The method of claim 12, wherein the generating the grouping information comprises:
generating first group information corresponding to a first content among the plurality of contents,
wherein the generating the index information comprises:
generating first index information corresponding to the first content among the plurality of contents, and
wherein the determining the keyword score comprises:
determining a keyword score for each keyword included in the first content using an Inverse Document Frequency (IDF) algorithm, a Term Frequency (TF) algorithm, and an NORM algorithm based on the first group information and the first index information.

14. A server comprising:
one or more processors; and
a memory configured to store one or more instructions,
wherein the one or more processors, by executing the stored one or more instructions, perform:
obtaining a content search term, the content search term including a first plurality of search keywords;
performing a search for a plurality of contents using the first plurality of search keywords;
extracting, based on no result of the search, a second plurality of search keywords from the first plurality of search keywords, wherein the second plurality of search keywords exclude keywords that are not included in a first keyword set, and the first keyword set includes keywords extracted from the plurality of contents; and
performing a search for the plurality of contents using the second plurality of search keywords.

15. The server of claim 14, wherein the one or more processors further perform, based on no result of the search for the plurality of contents using the second plurality of search keywords:
extracting a first keyword excluding keywords not included in a first content group from the second plurality of search keywords, and extracting a second keyword excluding keywords not included in a second content group from the second plurality of search keywords, wherein the first content group and the second content group are groups of contents included in the plurality of contents; and
performing a search for the first content group using the first keyword and performing a search for the second content group using the second keyword.

16. The server of claim 14, wherein the one or more processors further perform, based on there being no keyword that is not included in the first keyword set in the content search term:
extracting a first keyword excluding keywords not included in a first content group from the second plurality of search keywords, and extracting a second keyword excluding keywords not included in a second content group from the second plurality of search keywords, wherein the first content group and the second content group are groups of contents included in the plurality of contents; and
performing a search for the first content group using the first keyword and performing a search for the second content group using the second keyword.

17. The server of claim 16, wherein the one or more processors further perform:
determining rankings of the first content group and the second content group based on search results for the first content group and the second content group; and
providing a search result for a highest-ranked content group based on the determined rankings.

18. The server of claim 17, wherein the determining the rankings comprises:
extracting, from predetermined keyword score data, first keyword score data corresponding to a result of the search for the first content group using the first keyword;
extracting, from the predetermined keyword score data, second keyword score data corresponding to a result of the search for the second content group using the second keyword; and
determining the rankings of the first content group and the second content group using the first keyword score data and the second keyword score data,
wherein the predetermined keyword score data comprises keywords included in each content group and scores matching the keywords included in each content group.

19. The server of claim 18, wherein the first keyword score data and the second keyword score data are data determined using a BM25 algorithm.

20. The server of claim 14, wherein the plurality of contents are chatbot contents, and
wherein the content search term is a query entered by a user.
